(19) United States
(12) Patent Application Publication
(10) Pub. No.: US 2009/0129551 A1
(43) Pub. Date: May 21, 2009

(54) Electrode for X-ray apparatus

(75) Inventors: Peter Robert Butler, Manchester (GB); Simon Charles Page, Derbyshire (GB)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Kratos Analytical Limited

(21) Appl. No.: 12/285,608

(22) Filed: Oct. 9, 2008

(30) Foreign Application Priority Data
Oct. 7, 2007 (GB) 0719885.6

(51) Int. Cl. H05G 2/00; G01N 23/00

(52) U.S. Cl. 378/143; 250/310

(57) ABSTRACT

The present invention provides an electrode, typically an anode, for use in an x-ray generating apparatus comprising an electron source. The electrode comprises a housing, a diamond member mounted to the housing, and a target located on the diamond member, which target in use is bombarded with electrons from the electron source so as to generate x-rays. A bonding layer is located between the housing the diamond member, which bonding layer comprises an alloy having a solidus or melting point of less than 900° C. A particularly preferred alloy comprises silver, copper and indium. This arrangement assists in dissipating heat generated at the electrode surface whilst retaining the structural integrity of the electrode.

The present invention is concerned with an electrode for use in producing x-rays, particularly for use in x-ray photoelectron spectrometers. The invention is also concerned with x-ray photoelectron spectroscopy apparatus including such an electrode as well as methods of generating x-rays using the electrode and of conducting x-ray photoelectron spectroscopy using the electrode and apparatus.

X-rays for use in x-ray photoelectron spectroscopy (XPS) experiments are typically generated by accelerating electrons from an electron source (e.g. a filament) towards an anode held at a positive potential with respect to the electron source. The anode comprises a target material, typically aluminium or magnesium, which, when bombarded with electrons, generates x-rays.

The anode typically comprises a metal housing (for example a refractory metal, to withstand the high temperatures generated at the anode) to which is applied the target material, usually as a thin layer.

It is known that in conventional apparatus there is an upper limit to the flux of x-rays that can be generated from such an anode due to the very considerable heating of the anode that occurs when the electron beam is incident on the target material. Indeed, the elevated temperatures are such that the target material or even the material of the housing may start to melt at high electron beam powers.

This problem has been addressed to some extent by providing apertures or conduits in the anode housing through which cooling fluid can be passed.

Furthermore, it has been proposed that a diamond member can be incorporated into the anode housing, behind the target material, so as to increase the efficiency with which the thermal energy is transferred from the target material to the bulk of the housing and/or the coolant fluid.

Despite these developments, the present inventors have noted that the performance of anodes in x-ray generating apparatus, in particular XPS apparatus, is limited in terms of x-ray flux, which in turn limits the quality of data obtainable from XPS samples. In practice, longer acquisition times are needed, to compensate for the lower flux, with the obvious disadvantage that less samples can be processed using a particular apparatus.

In particular, the present inventors found that, even when a diamond member is used, the generation of heat by the incident electron beam can be such as to cause structural problems with the anode. In particular, the present inventors have found that it is difficult to reliably attach the diamond member to the housing. The diamond member may become detached from the housing during the periods of elevated temperature that occur when the electron beam is incident on the anode. Repeated increases and decreases of temperature provide a very harsh environment at the anode and the present inventors have observed that known methods for mounting the diamond member to the housing are not robust enough to deal with such harsh conditions. A consequence of this is that electron beam powers must be kept sufficiently low in order to maintain structural integrity. Thus, at least to some extent, the potential advantages of using a diamond member cannot be realised in practice.

At its most general, the present inventors propose that a diamond member can be attached to a housing a bonding layer comprising an alloy having a low melting temperature (specifically, either a low minimum temperature at which melting starts—“solidus”—or a low melting point). Suitably the alloy is a low temperature brazing alloy. The present inventors have found that a low melting temperature alloy provides a robust connection between the diamond member and the housing. It is believed that the low melting temperature of the alloy (i.e. low temperature solidus or melting point) is indicative of a correspondingly low differential thermal expansion between diamond and braze, which the present inventors have found through experimentation to be desirable when bonding a diamond member to an electrode (anode) housing.

Alloy compositions referred to herein in terms of percentages (%) are percentages by weight based on total weight of the alloy.

In a first aspect, the present invention provides an electrode for use in an x-ray generating apparatus comprising an electron source, the electrode comprising
a housing;
a diamond member mounted to the housing; and
a target located on the diamond member, which target in use is bombarded with electrons from the electron source so as to generate x-rays, wherein a bonding layer is located between the housing and the diamond member, the bonding layer comprising an alloy having a solidus or melting point of less than 900° C.

The melting range for an alloy, for example a brazing alloy, is defined by the minimum temperature at which the alloy starts to melt (“solidus”) and the temperature at which the alloy is 100% liquid (“liquidus”).

Eutectic alloys behave like pure metals and have a melting point.

Values for the solidus and the liquidus for a very large number of alloys (and melting points for eutectic alloys) are well documented. Typically, the solidus and liquids are reported as a “melting range”. Similarly, the measurement of solidus, liquidus and melting point is a well established technique.

Thus, the present invention permits the thermal properties of diamond to be used effectively, by securely attaching the diamond member to the end of the copper electrode body. The diamond member can then be coated with a target material such as aluminium to form a reliable bond between housing, diamond and target. Furthermore, the bonding layer provides an ultra high vacuum (UHV) seal and is useable at the high temperatures (e.g. 200 to 650° C.) present when the electrode is in use.

The present inventors have found that by providing a bonding layer comprising a metal alloy having solidus or a melting point of less than 900° C., the reliability of the bond between the diamond member and the electrode housing can be significantly increased. This means that the advantage of using a diamond member, namely improved heat transfer from the target, can be realised.

Typically, the electrode is for use as an anode in an x-ray photoelectron spectrometer.

Whilst a bonding layer having a solidus or melting point of less than 900° C. provides reliable bonding between the diamond and the housing, even better performance, in terms of a more durable and reliable bond (and hence electron beam power that can be tolerated without failure of the bond at a given operating temperature) can be achieved when the alloy has a solidus or melting point of less than 800° C., which is preferred.

Whilst there is no specific requirement for a lower limit to the solidus or melting point of the alloy of the bonding layer, typically the lower limit is about 500° C.

Preferably the alloy has a solidus or melting point in the range 550 to 800° C., more preferably in the range 600 to 750° C., even more preferably in the range 650 to 750° C., even more preferably in the range 650 to 700° C. and most preferably in the range 675 to 695° C.

Suitably the liquidus occurs at a temperature of less than about 1000° C., preferably less than about 900° C., more preferably less than about 800° C. and most preferably and less than about 950° C.

Suitably, the melting range (i.e. solidus and liquidus) of the alloy occurs within the temperature range 550 to 800° C., more preferably in the range 600 to 750° C. and most preferably in the range 650 to 750° C.

Suitably the bonding layer is formed by brazing, but other techniques can also be used to bond the diamond member to the housing with the alloy of the bonding layer, for example friction welding.

Suitably the alloy is selected from (1) a silver-copper eutectic; and (2) an alloy comprising silver and/or copper and at least one additional metal.

Thus, under alloy option (2), the alloy can comprise either (i) silver and at least one additional metal; (ii) copper and at least one additional metal; or (iii) silver, copper and at least one additional metal.

Preferably the alloy comprises silver and/or copper and at least one additional metal selected from indium, tin, manganese, nickel, titanium and aluminium. Indium, manganese and nickel are particularly preferred, especially indium.

The alloy can also be an active braze alloy, which are known to those skilled in the art. An active braze alloy suitably contains titanium. An advantage of using an active braze alloy is that very good bonding can be achieved without using intermediate layers, particularly first and second intermediate layers as discussed herein. Preferred examples of active braze alloys are Cusil-ABA (Ag 63%, Cu 35.25%, Ti 1.75%), Incusil-ABA (Ag 59%, Cu 27.25%, In 12.5%, Ti 1.25%), Silver-ABA (Ag 92.75%, Cu 5%, Al, 1%, Ti 1.25%) and Ticusil-ABA (Ag 68.8%, Cu 26.7%, Ti 4.5%), all of which are available from Wesgometals.

A particularly preferred alloy comprises silver, copper and indium.

Whilst high purity alloys are preferred, even commercially available alloys may contain impurities. Thus, preferably the alloy comprises no more than 0.5 wt %, more preferably no more than 0.1 wt %, most preferably no more than 0.01 wt % impurities. Suitably, the alloy consists essentially of, preferably consists of, the metals specified herein. Preferably the alloy conforms to standard EN 1044:1999 for impurity levels.

In preferred electrodes, the alloy comprises, by weight of the total alloy, 55 to 70 wt % silver, 20 to 35 wt % copper and 1 to 15 wt % of at least one additional metal.

Indium is particularly preferred as the additional metal. Accordingly, in a preferred electrode, the alloy comprises, by weight of the total alloy, 55 to 70 wt % silver, 20 to 35 wt % copper and 5 to 15 wt % indium.

More preferably the alloy comprises 60 to 65 wt % silver, 25 to 30 wt % copper and 8 to 12 wt % indium, and most preferably about 63 wt % silver, about 27 wt % copper and about 10 wt % indium.

The thickness of the bonding layer is selected to provide adequate strength but without introducing an unnecessary impediment to the transfer of heat from the target to the housing.

Preferably the bonding layer has a thickness in the range 10 μm to 200 μm, more preferably in the range 20 μm to 100 μm, still more preferably in the range 35 μm to 65 μm, and most preferably about 50 μm.

Suitably, the thermal conductivity of the alloy is >50 W/mK, preferably >75 W/mK and most preferably >80 W/mK. For example, the thermal conductivity of the preferred IN10 braze referred to herein is 85 W/mK (an alloy having the same composition as IN10 is also available from Wesgometals as incusil 10).

In practice, the thickness of the bonding layer can be adjusted to provide an acceptable thermal conductivity, whilst maintaining effective bonding.

Suitably the housing is formed from a metal selected from copper, silver, tungsten, molybdenum, tantalum, niobium and rhenium.

Preferably the housing is formed from copper.

Preferably the housing includes a recess for receiving the diamond member.

The housing of the electrode is used to mount the electrode to the instrument. Therefore, suitably, the electrode includes mounting means for mounting the electrode to the instrument, preferably for mounting the electrode within a vacuum chamber of an x-ray generating instrument, e.g. an x-ray photoelectron spectrometer. Suitably the mounting means provide a UHV seal.

In a preferred arrangement, the housing (suitably a copper housing) is brazed onto a stainless steel tube that houses the coolant pipes (typically water pipes). This assembly is in turn attached to the vacuum chamber via a ceramic HV insulator.

To assist in removing heat from the housing, and hence the target, the housing preferably comprises at least one conduit for receiving a coolant fluid.

To further improve heat transfer, the housing preferably comprises a plurality of heat sink projections extending into the or each said at least one conduit.

The distance between the diamond wafer and the conduit(s) is preferably selected to provide a balance between structural strength (of the housing) and heat transfer.

Preferably the diamond member is separated from the conduit by a wall portion of the housing, the wall portion having a thickness in the range 0.5 mm to 5 mm, more preferably in the range 1 mm to 2 mm, and most preferably about 1.5 mm.

In an alternative arrangement, one or more surfaces of the diamond member may form part of the conduit wall, or impinge into the conduit. Thus, in preferred embodiments, the diamond member is mounted to the housing with respect to the at least one conduit such that in use the diamond member is exposed to the coolant fluid.

Suitably the target and housing are located on opposite sides of the diamond member.

The present inventors have found that the problem of providing a reliable bond between the diamond member and the housing, which bond must be able to withstand high temperatures, can be further ameliorated if an intermediate layer adapted to improve bonding is formed between the bonding layer and the diamond. Such a layer containing titanium and/or chromium has been found to improve adhesion between the diamond and housing.

Therefore, in preferred arrangements, a first intermediate layer is located between the bonding layer and the diamond member, said first intermediate layer comprising at least one of titanium, chromium or titanium nitride. Preferably the first intermediate layer comprises titanium.

However, preferably the first intermediate layer consists essentially of titanium.

Preferably the first intermediate layer is thinner than the bonding layer. Indeed it is better if it is not too thick, to avoid impeding heat transfer.

Thus, preferably, the first intermediate layer has a thickness in the range 0.01 to 0.2 μm, more preferably in the range 0.02 to 0.1 μm, still more preferably in the range 0.05 to 0.07 μm, and most preferably about 0.06 μm.

In addition to the first intermediate layer, the present inventors have found through experimentation that a second intermediate layer, located between the first intermediate layer and the bonding layer. Such an additional layer, adapted to bond to the first intermediate layer and/or the bonding layer can further improve bonding and reliability. Furthermore, such a second intermediate layer suitably acts as a barrier layer to prevent diffusion (mixing) of the adjoining materials.

Accordingly, preferably a second intermediate layer is located between the bonding layer and the first intermediate layer, the second intermediate layer comprising at least one of platinum, tungsten, titanium, molybdenum and tantalum.

Suitably the second intermediate layer consists essentially of platinum.

As discussed for the first intermediate layer, the second intermediate layer is typically thinner than the bonding layer and this has been found to be suitable for improving reliable bonding. Furthermore, generally the second intermediate layer is thicker than the first. intermediate layer, an arrangement which has been found to contribute to the high temperature reliability of the electrode.

Suitably the second intermediate layer has a thickness in the range 0.05 to 0.5 μm, preferably in the range 0.08 to 0.2 μm, more preferably in the range 0.1 to 0.15 μm and most preferably about 0.12 μm.

As a result of further tests and experiments, the present inventors have found that further improvements in the reliability of the bonding between diamond and housing can be achieved if a third intermediate layer is formed between the second intermediate layer and the bonding layer. Thus, the third intermediate layer is suitably adapted to adhere to the bonding layer and/or second intermediate layer.

Thus, a third intermediate layer is preferably located between the bonding layer and the second intermediate layer, the third intermediate layer comprising at least one of gold, silver, indium, aluminium and magnesium.

Suitably the third intermediate layer consists essentially of gold.

As for the first and second intermediate layers, the third intermediate layer is preferably considerably thinner than the bonding layer. However, it is generally thicker than the first intermediate layer. Typically it is thicker than the second intermediate layer.

Accordingly, the third intermediate layer preferably has a thickness in the range 0.2 μm to 5 μm, more preferably in the range 0.5 μm to 2 μm, still more preferably in the range 0.8 μm to 1.2 μm, and most preferably about 1 μm.

Suitably the diamond member is formed from a synthetic diamond, although natural diamond can be used.

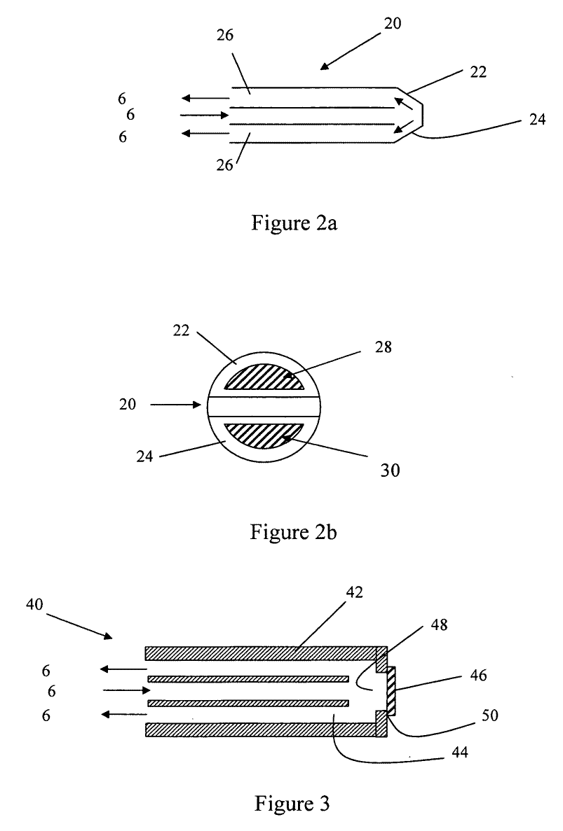

The diamond wafer acts as a heat sink. Different grades of natural or synthetic diamond are commercially available and these have different thermal conductivities, which will affect the efficiency of the diamond as a heat sink. The higher the thermal conductivity of the diamond the more suitable it is for this application. The thickness of the diamond also affects the performance of the diamond as a heat sink. The diamond thickness can be adjusted to suit the range of electron beam spot sizes used in the instrument. The shape of the diamond on the anode can also be varied to suit individual requirements. For example, two semicircular pieces could be used on an anode having a shape that includes two targets, for example an electrode designed to produce either aluminium or magnesium x-rays (see FIG. 2, discussed below).

The characteristics of the diamond are suitably selected to provide optimum heat transfer and/or compatibility with the bonding layer and any intermediate layers that may be present. Thus, suitably, the diamond member comprises diamond having a thermal conductivity of at least 1200 W/mK at 300 K, preferably at least 1500 W/mK, more preferably at least 1700 W/mK and most preferably at least 1800 W/mK. Preferably the thermal conductivity is at least as good as that of a type 2a natural diamond.

Suitably, the diamond has a thermal diffusivity of >10 cm²/s at 300 K.

Suitably the diamond member is monocrystalline.

Preferably the diamond member is thicker than the bonding layer.

Typically, the diamond member has a thickness in the range 50 μm to 1000 μm, preferably in the range 150 μm to 800 μm, more preferably in the range 300 μm to 500 μm and most preferably about 400 μm.

The target layer is selected to generate the required characteristic X-rays. This layer should generally be as thin as possible to reduce the thermal conductivity barrier between the diamond and the outer face of the target layer. However, the layer should preferably be thick enough to ensure that the lifetime of the coating is sufficiently long, in view of the fact that the layer may become depleted when the anode is used.

Suitably the target comprises at least one of aluminium and magnesium. Aluminium is particularly preferred. Suitably the target consists essentially of aluminium.

Additionally or alternatively to aluminium or magnesium, other materials may be used as the coating to allow x-rays of different characteristic wavelengths to be produced. Typically these materials are selected from silver, zirconium and tungsten. One or more of these coatings may be simultaneously present on the anode, preferably as discrete targets (e.g. discrete regions). A suitable arrangement of multiple targets is shown in FIGS. 2a and 2b.

One way of ensuring that the desired potential can be applied to the target is to use the target material to provide an electrically conducting path to the housing. Thus, preferably the target is located on an upper face of the diamond member and extends from the upper face along at least one side face of the diamond member to the housing, thereby forming an electrical contact between the target and the housing.

Suitably the target has a thickness in the range 10 μm to 200 μm, preferably in the range 20 μm to 100 μm, more preferably in the range 35 μm to 65 μm and most preferably about 50 μm.

As well as improving bonding between the diamond member and the housing, the present inventors have also found that improvements in reliability and/or heat transfer can be achieved if an intermediate layer is provided between the target and the diamond. Such an intermediate layer can be provided independently of the intermediate layers between the bonding layer and diamond layer, although it is preferred that such layers are provided on both sides of the diamond member.

Thus, suitably a fourth intermediate layer is located between the target and the diamond member, the fourth intermediate layer being as defined for the first intermediate layer discussed above.

Preferably the fourth intermediate layer has a thickness of about 0.1 μm.

Suitably the fourth intermediate layer is thicker than the first intermediate layer (if the first intermediate layer is present—it does not need to be in order for there to be a fourth intermediate layer).

It has been found that further improvements in reliability and high temperature performance can be achieved if a fifth intermediate layer is placed between the fourth intermediate layer and the target.

Thus, preferably a fifth intermediate layer is located between the target and the fourth intermediate layer, the fifth intermediate layer being as defined for the second intermediate layer discussed above.

Preferably the fifth intermediate layer has a thickness of about 0.1 μm.

Suitably the fifth intermediate layer is thinner than the second intermediate layer.

In further aspects, the present invention provides the use, in an electrode for use in an x-ray generating apparatus comprising an electron source, the electrode comprising

a housing;

a diamond member mounted to the housing; and

a target mounted on the diamond member,

of any one or more of a bonding layer, a first intermediate layer, a second intermediate layer, a third intermediate layer, a fourth intermediate layer and a fifth intermediate layer as defined herein.

Suitably, such use includes use in a method of manufacturing such an electrode.

In further aspects, the present invention provides an electrode for use in an x-ray generating apparatus comprising an electron source, the electrode comprising

a housing;

a diamond member mounted to the housing; and

a target mounted on the diamond member, wherein the electrode further comprises any one or more of a bonding layer, a first intermediate layer, a second intermediate layer, a third intermediate layer, a fourth intermediate layer and a fifth intermediate layer as defined herein.

In particular, as noted above, the present inventors have found that the use of first intermediate layer between a bonding layer and a diamond member can significantly improve reliability and performance of the electrode in an XPS spectrometer. Indeed, the present inventors have found that such advantages can be achieved even when the bonding layer is not as defined according to the first aspect. Thus, the use of such an intermediate layer has wider applicability and can be used in conjunction with any metal-containing bonding layer.

Thus, in a further aspect, the present invention provides an electrode for use in an x-ray generating apparatus comprising an electron source, the electrode comprising

a housing;

a diamond member mounted to the housing; and

a target mounted on the diamond member, which target in use is bombarded with electrons from the electron source so as to generate x-rays, wherein a metal-containing bonding layer is located between the housing and the diamond member, and a first intermediate layer is located between the bonding layer and the diamond member, the first intermediate layer comprising at least one of titanium and chromium.

Suitably any such bonding layer comprises a metal alloy. Preferably the bonding layer is as defined in the first aspect.

Preferably the first intermediate layer is as defined in the first aspect.

The advantages of using one or more of the additional intermediate layers can also apply to this aspect. Accordingly, preferably the electrode comprises one or more of a second intermediate layer, third intermediate layer, fourth intermediate layer and a fifth intermediate layer according to the first aspect.

Similarly, any one of the diamond member, target and housing are preferably as defined in the first aspect.

In a further aspect, the present invention provides an electrode for use in an x-ray generating apparatus comprising an electron source, the electrode comprising

a housing;

a diamond member mounted to the housing; and

a target located on the diamond member, which target in use is bombarded with electrons from the electron source so as to generate x-rays, wherein a bonding layer is located between the housing and the diamond member, the bonding layer comprising an alloy comprising silver, copper and optionally at least one other metal.

Preferably the alloy comprises silver, copper and indium. Also preferred is a silver-copper eutectic.

Suitably the alloy comprises, by weight of the total alloy, 55 to 70 wt % silver, 20 to 35 wt % indium. The optional and preferred features of the other aspects preferably also apply to this aspect.

In a further aspect, the present invention provides apparatus for generating x-rays, said apparatus comprising an electrode according to any one of the previous aspects and an electron source, wherein in use electrons are produced from said electron source and can be incident on the target of the electrode.

Suitably the electron source comprises a filament.

Preferably the apparatus includes accelerating means for accelerating the electrons towards the target.

Suitably the apparatus includes voltage supply means adapted to apply a positive potential to the electrode relative to the electron source. Typically, the positive potential is at least 10 kV, preferably about 15 kV.

Preferably the electron source is earthed. Alternatively, the anode can be earthed, in which case the electron source (typically a filament) is held at a negative potential, suitably such that the anode is at a positive potential of 10 to 15 kV with respect to the electron source.

The electron beam size on the electrode (the “spot-size”) could potentially be of any size from 1 μm diameter or less, up to the size of the electrode face (suitably the target face), typically in the order of 10 mm diameter. However, it is advantageous for the electron beam to be significantly smaller than the anode face. Thus, preferably, the spot size is about 0.5 mm×1 mm.

Suitably the apparatus comprises electron optics for directing the electrons onto the target. Preferably the electron optics are adapted to direct electrons onto a target area of the target, the target area being at least 0.15 mm², more preferably at least 0.35 mm² and most preferably at least 0.45 mm².

The spot size may be fixed or variable in size. In preferred embodiments the apparatus is adapted to provide a variable spot size. Suitably the apparatus includes spot size variation means so that the spot size can be varied between experiments, for example to analyse different sample feature sizes.

A fixed spot size is preferred for generating a parallel photoelectron image of a sample. That is a fixed spot is preferred while a parallel image is recorded. However the spot size can be varied between experiments provided it is not varied during the recording of an image. Similarly the spot size is preferably fixed during recording of a spectrum.

An advantage of a variable spot size is that higher quality spectra can be obtained from a range of selected areas, that is spectra with an increased signal to noise ratio given the same acquisition time. In addition, a large spot size can be used for recording a parallel image and in a different experiment a smaller spot size can be used to obtain higher quality data from a smaller selected area on the sample.

The shape (cross-section) of the electron beam is typically circular or rectangular, but can be any shape, provided the electron beam optics can be set up to produce such a shape.

The electron beam may impinge a fixed location on the electrode. Alternatively it may be controllable so that the electron beam can be directed onto a range of locations on the anode (i.e. a variable spot position). Thus, the apparatus may be adapted to raster the electron beam through a range of positions. An advantage of a controllable beam is to extend the useful lifetime of the anode because over time the anode surface where the electron beam impinges will become damaged. Therefore, in preferred embodiments, the apparatus includes an electron beam controller for controlling the location of the electron beam spot on the anode. In particular, the electron beam controller is suitably configured to raster the electron beam spot over the anode.

In alternative embodiments, the anode is moved so as to change the position of the anode with respect to the electron beam. This arrangement is useful because the spot illuminated on the anode does not move with respect to the monochromator and hence sample and hence analyser analysis position. This extends the operational life of the anode. Suitably, the apparatus includes anode moving means to move the anode.

Preferably the apparatus comprises a spherical mirror analyser, preferably also a hemispherical analyser, which terms are known to those skilled in the art. A suitable spherical mirror analyser and hemispherical analyser are described in GB-A-2244369. Preferably the apparatus includes the electron analyser described in patent GB-A-2244369.

Preferably the apparatus comprises a delay line detector. A suitable delay line detector is described in GB-A-2397940.

To assist in removing heat from the electrode, preferably the apparatus comprises coolant fluid means for delivering coolant fluid to the electrode.

Preferably the apparatus comprises an x-ray monochromator.

In a further aspect, the present invention provides an x-ray photoelectron spectrometer comprising an electrode according to any one of the previous aspects.

In a further aspect, the present invention provides a method of generating x-rays using an electrode or apparatus according to any one of the previous aspects.

In a further aspect, the present invention provides an x-ray photoelectron spectroscopy method in which an electrode or apparatus according to any one of the previous aspects is used.

In such a method, preferably the electrode is cooled by water and the temperature of the water in the electrode is maintained below boiling.

As well as the advantages associated with the various improved bonding methods disclosed herein, the present inventors have found that particularly good results can be achieved in terms of x-ray count, signal to noise and image generation, if an electrode comprising a diamond member located between the target and the housing is used in an x-ray photoelectron spectrometer having a spherical mirror analyser and a delay line detector. Indeed, even in the absence of the bonding layers and/or intermediate layers discussed herein, the present inventors have found that surprisingly good results can be achieved in such an apparatus. Thus, this narrow class of spectrometer is suitably adapted to provide improved performance by using a diamond-containing anode.

In a further aspect, the present invention provides an x-ray photoelectron spectrometer comprising an x-ray source, a spherical mirror analyser and a delay line detector, wherein the x-ray source comprises an electron source and an electrode, the electrode comprising

a housing;

a diamond member mounted to the housing; and

a target located on the diamond member, which target in use is bombarded with electrons from the electron source so as to generate x-rays.

Suitably any one of the housing, target and diamond member are as defined in the previous aspects.

Preferably the spectrometer includes an x-ray monochromator.

Preferably the spectrometer is adapted or configured to obtain images of a sample.

Suitably the spectrometer includes a hemispherical analyser.

Each of the aspects previously described may be combined with one, more than one or all of the other aspects, and features within each of the aspects may be combined with features from the other aspects.

Embodiments of the invention are described below, by way of example only, with respect to the accompanying drawings, in which:

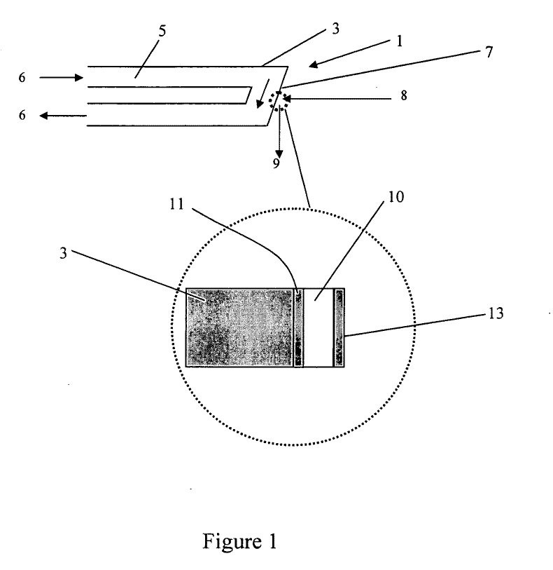

FIG. 1 shows an enlarged sectional view of an electrode;

FIG. 2a shows schematically an electrode having two target faces;

FIG. 2b shows the electrode of FIG. 2a end-on;

FIG. 3 shows an electrode wherein a cooling fluid impinges directly onto a diamond member;

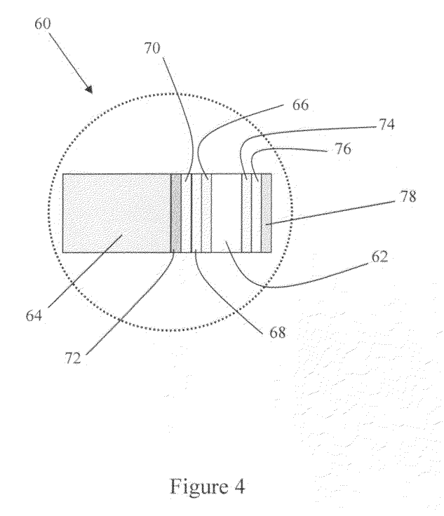

FIG. 4 shows a sectional view of an electrode having intermediate layers between the diamond member and housing;

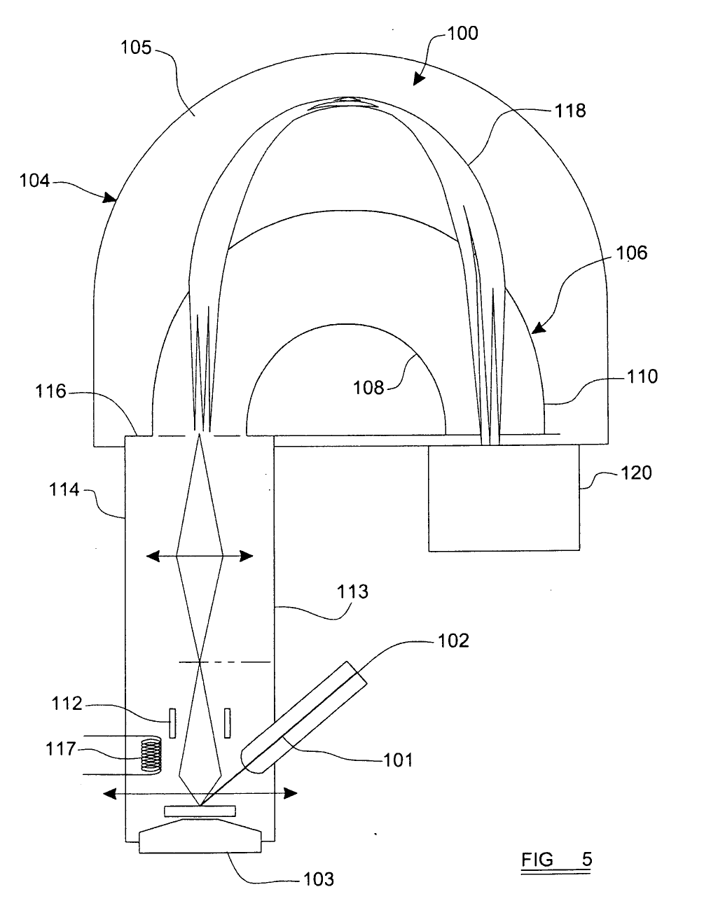

FIG. 5 shows an XPS instrument configured to operate in an image mode; and

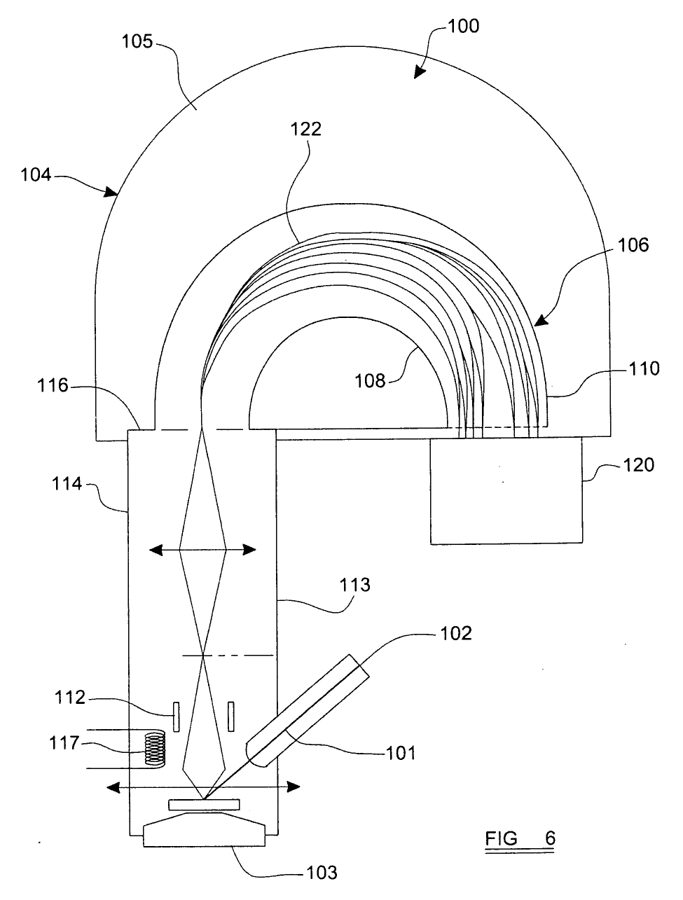

FIG. 6 shows an XPS instrument configured to operate in a spectral mode.

The electrode 1 shown in FIG. 1 comprises a housing 3 made from copper. The housing includes a conduit in the form of a channel or bore 5 extending through the housing. During use, a coolant fluid, typically water, is pumped through the channel/bore 5 to remove heat from the housing (as indicated by arrow 6). At a target end 7 of the housing (which target end is, in use, bombarded with an electron beam 8 to produce x-rays 9), a thin wafer of diamond 10 is mounted to the housing.

The close-up view of the housing shows the diamond wafer 10 in section. It is 400 μm thick, but other thicknesses could be used, e.g. 50 μm to 1 mm. It is mounted to the housing 3 by a bonding layer 11.

The bonding layer 11 consists of In10 braze, 50 μm thick. The In10 braze comprises Ag (63%), Cu (27%) and In (10%) and is available from Johnson Matthey. However, other relative amounts of Ag, Cu and In may be used. The melting temperature range of In10 is 685-730° C. (i.e. the solidus is 685° C. and the liquidus is 730° C.). Other alloys having a similar solidus or similar melting temperature range may be used instead.

As discussed above, the present inventors have noted that it is difficult to form bonds between metals and diamond or metallised diamond (diamond coated in a thin layer of metal) because the difference between the thermal expansion coefficients of the metal and the diamond are typically so large that large stresses build up in the join and cause the bond to fail. However, the present inventors have found that the In10 braze, and brazes having similar characteristics, forms a surprisingly strong and robust bond between the diamond and the anode body, even at the high temperatures experienced during use. In particular, the present inventors have identified the comparatively low solidus of the In10 braze (685° C.) as being important in providing such a reliable high temperature-resistant bond.

The main function of the In10 braze is therefore to bond the diamond to the main body of the anode. However, surprisingly, it has also been found to possess properties that allow it to reduce the stress caused by the difference in thermal expansion between the copper body of the anode and the diamond when the anode is operating at elevated temperatures. It is believed that the comparatively low melting temperature of the In10 alloy provides a correspondingly low thermal expansion. This has been found to be particularly advantageous because it compliments the thermal expansion (properties) of diamond, thereby reducing stress. Thus, In10 braze is particularly good because it has a low thermal expansion coefficient that is similar to diamond. This property ensures that the braze not only bonds well to the diamond but that any stresses that occur do so in the braze to metal join, which is much stronger than the braze to diamond join. A common silver-copper eutectic (no indium) also does a similar job, although it has a higher melting point and is therefore slightly less preferred.

Indeed, the present inventors have found that the lower the melting point of the braze the more successful it is likely to be in bonding the diamond to the metal housing, because less stress occurs due to less thermal expansion. However, the diamond, alloy (braze) and metal housing will all get hot in use and so the alloy (braze) must not have too low a melting point, otherwise it will re-melt when the anode is in use.

On the opposite face of the diamond wafer to the bonding layer 11, a target 13 in the form of a target layer is bonded to the diamond wafer. The target layer consists of Al, with a thickness of 50 μm.

Thus, one face of the diamond wafer is bonded to the housing 3 that is cooled in use. The electrode is used within the vacuum chamber of an instrument that is capable of performing XPS (the instrument may perform this technique only or other techniques as well). In preferred embodiments (such as the one shown in FIGS. 5 and 6), the XPS instrument uses a spherical mirror analyser (SMA). Furthermore, the XPS instrument preferably comprises a spherical mirror analyser and a delay line detector (DLD), e.g. of the sort described in GB-A-2397940, (such as the arrangement shown in FIGS. 5 and 6).

Indeed, the present inventors have found that higher sensitivity can be achieved using an electrode comprising a diamond member bonded to the housing of the electrode with bonding layer 11 as shown in FIG. 1. In particular, better signal to noise and hence more useful images and spectra can be obtained, compared to the use of a ‘normal’ electrode.

In use, x-rays are generated by an electron beam impinging on the target 13 (i.e. the outer metallic coating) of the electrode when the electrode is held at a positive potential with respect to the filament used to generate the electrons. Thus, in this embodiment, the electrode is an anode. In this embodiment, the spot size is about 0.5 mm×1 mm, but other sizes and shapes can be used.

As noted above, X-ray production is very inefficient and consequently the majority of the energy contained in the electron beam is dissipated as heat in the anode. The heat generated on the surface of the anode builds up and can cause the outer metallic coating to eventually melt and or sublimate.

However, by mounting a diamond member such as the diamond wafer 10 shown in FIG. 1 to the anode body (housing) using a bonding layer such as the Ag—Cu—In braze discussed above, the heat generated at the anode surface can be more efficiently dissipated whilst retaining the structural integrity of the anode. Thus, this design brings about an increase in power density at the anode. This means that a higher x-ray flux density can be generated from an anode utilising this design.

The wafer of synthetic diamond 10 is circular and is 10 mm in diameter. This permits a large stationary spot to be used, which has been found to be advantageous when the anode is used with a spherical mirror analyser, for example to produce a photoelectron image, preferably a real time photoelectron image of a sample.

The outer metallic coating (target 13) extends down the sides of the diamond wafer (not shown) and thereby forms an electrical contact with the anode housing 3.

The copper anode body directly under the diamond wafer is about 1.5 mm thick. The internal surface of the copper under the diamond has a surface in contact with the coolant fluid (water). Thus, the internal surface of the copper is water cooled.

The manufacturing process for making the anode 1 is described below. The diamond wafer 10 is first brazed to the copper anode housing 3 via the In10 braze layer 11. The upper face of the diamond is then coated in aluminium to form target 13.

The diamond is first coated (on the face destined to be bonded to the housing) with Ti, followed by a coating of Pt and Au. The coating process used for each layer is ion plating. The diamond is then brazed to the anode body using In10. The anode body contains a recess into which the diamond is placed to prevent the diamond from moving out of position during the braze process. Furthermore moderate pressure is applied to the diamond (for example, it is clamped in place) during the braze process to prevent the diamond from moving out of position during the braze process. The pressure (clamp) also helps to ensure that the braze joint is even and complete across the whole surface of the diamond.

The braze process used with the In10 braze is a vacuum braze process with an RF generator brazing machine to ensure that only a limited part of the anode is heated to the braze temperature. Other braze processes and machines could be used, particularly if different materials and or brazes are used.

Once the diamond is brazed to the body of the anode, the upper face and sides of the diamond are coated in Ti, Pt and Al to form respective layers of those metals. The coating process used for each layer is ion plating.

In FIGS. 2a and 2b, electrode 20 has two target faces, each cooled by water flow through conduits 26. In FIG. 2b, first target face 22 comprises a semicircular target layer 28 formed from aluminium. Second target face 24 comprises a semicircular target layer 30, made from magnesium. Both target layers are bonded to correspondingly shaped diamond members (not shown).

As noted above, the anode body/housing 3 contains channels for coolant fluid and there is therefore a UHV seal between the coolant fluid channels and the vacuum chamber that the anode is housed within.

Suitably, the anode housing material has a high thermal conductivity to maximise the cooling of the aluminium target layer. In preferred embodiments (see e.g. FIGS. 1, 2a and 3) the anode is made from copper and is water cooled, although other fluid coolants could be used. The thickness of the copper under the diamond and the design of the fluid channels can be optimised for the individual design of the anode and the size of the electron beam spot impinging on the anode. Other materials may be used to form the anode body. The most suitable alternative materials also have a high thermal conductivity such as silver, tungsten, molybdenum, tantalum, niobium and rhenium.

The diamond wafer acts as a heat sink. Different grades of natural or synthetic diamond are commercially available and these have different thermal conductivities, which will affect the efficiency of the diamond as a heat sink. Generally, the higher the thermal conductivity of the diamond the more suitable it is for this application. The thickness of the diamond also affects the performance of the diamond as a heat sink. The diamond thickness can be adjusted to suit the range of electron beam spot sizes used in the instrument. The shape of the diamond on the anode can also be varied to suit individual requirements. For example, two semicircular pieces could be used on an anode of a different shape designed to produce either aluminium or magnesium x-rays (see FIG. 2).

The design of the anode can vary considerably, another conceivable design would be to fix the diamond over a hole in the end of the copper body of the anode so that the coolant is in contact with the majority of one of the faces of the diamond. FIG. 3 shows an example of such an arrangement. The electrode 40 comprises housing 42 containing conduits 44 through which water (or other fluid) is pumped during use. Diamond member 46 is mounted over an aperture 48 in the housing such that the diamond member is in direct contact with the coolant fluid in use. The diamond member 46 is bonded to the housing at flange 50. The seal between the diamond and the body of the anode is vacuum tight to UHV standards. The same bonding structure described above is used to achieve the bond between the diamond and the flange of the anode housing. The optimum thickness of the diamond may vary in this arrangement depending on the exact design.

Another significant problem addressed by the present invention is to form good quality coatings on the diamond (i.e. good quality targets).

Thus, the present inventors have observed that if, for example, a suitable braze (bonding layer) is applied not directly to the diamond surface, but to an intermediate layer, then a stronger region can be formed. Similarly, the present inventors have found that forming an intermediate coating between the diamond and the target (e.g. aluminium) can bring about stronger adhesion and better durability of the target (which might otherwise be liable to come off when the anode is in use). Thus, providing an intermediate layer (metallising the diamond) means that there is a reduced risk of damaging the target coating when fitting the anode into the instrument.

In the embodiment shown in FIG. 4 (discussed in more detail below), a diamond is first coated with a thin layer of titanium. Titanium can be made to adhere strongly to diamond. Once the diamond is coated in titanium it is possible to apply other coatings, as they will adhere well to the titanium layer. Thus, titanium adheres to diamond with good strength, and is used to allow other materials to be bonded to the structure. Materials other than titanium may be used for this purpose, such as chromium. The titanium layer should preferably be as thin as possible to reduce the thermal conductivity barrier between the diamond and copper (similarly between diamond and aluminium). The titanium must be thick enough to provide a coating to the diamond to allow other materials to be bonded to the structure.

Further improvements in reliability and bond strength can be achieved by applying a further intermediate layer to the first intermediate layer (typically titanium). Thus, a thin platinum layer is preferably applied to cover the titanium layer. The platinum layer is a barrier layer and prevents diffusion (or mixing) or subsequent layers with the titanium layer and vice versa. The platinum layers are used as barrier layers to prevent diffusion of the other layers past the barrier when the anode is in use and consequently at elevated temperatures (200-600° C.). Diffusion and consequently mixing of the various layers reduces their performance and must therefore be prevented. The platinum layers should preferably be as thin as possible to reduce the thermal conductivity barrier between the diamond and the aluminium and copper. The platinum layers should preferably be thick enough to provide an effective diffusion barrier. Other materials maybe used as barrier layers such as tungsten.

It is also possible to coat the diamond with a third layer, to further improve reliability and bond strength. Thus, on the face of the diamond which is bonded to the housing, the third layer is gold. This gold layer further aids the formation of a strong bond between the bonding layer (braze) and the coated diamond. The gold layer is used to improve the strength of the adhesion of the diamond coated structure to the e.g. In10 braze. The layer should preferably be as thin as possible to reduce the thermal conductivity barrier between the diamond and the main body of the anode. The layer should preferably be thick enough to ensure good adhesion between the braze and the diamond coated assembly. Other materials may be used as the coating to improve adhesion to the braze.

With these preferred features in mind, FIG. 4 shows an electrode 60 having the intermediate layers discussed above. Thus, diamond wafer 62 (TM180 synthetic diamond, 400 μm thick, (available from Element Six B.V) is bonded to copper housing 64 via Ti layer 66 (0.06 μm thick), Pt layer 68 (0.12 μm thick), Au layer 70 (1 μm thick) and In10 braze layer 72 (50 μm thick).

On the opposite face of the diamond wafer 62, a Ti layer 74 (0.1 μm thick) and a Pt layer 76 (0.1 μm thick) lie between the diamond and target layer 78 formed of Al (50 μm thick). This arrangement provides a particularly robust bond between the diamond and the anode housing and the Al target layer. When used in an x-ray generating instrument (e.g. XPS apparatus), higher fluxes of x-rays can be produced because of the excellent heat dissipation provided by the diamond and bonding layers.

As discussed above, the various layers and especially the bonding layer experience temperatures (e.g. 200 to 650° C.) considerably greater than those experienced by e.g. brazes in the electronics industry.

FIG. 5 shows an XPS instrument 100 in which the anode 101 is used within a source 102 for generating x-rays. The x-ray source includes the anode and an electron beam generator (in this embodiment, including a hot filament, not shown) that produces a beam of electrons that can be directed toward the anode. The anode 101 is held at a positive potential with respect to the filament, for example +15000 V in a preferred embodiment. The outer coating on the anode where the beam of electrons impinges determines the characteristic x-rays that are generated. The spot size on the anode is controlled by the design of the electron optics (not shown) between the electron beam generator and the anode. As discussed above, the electron beam spot size on the anode is fixed in this embodiment, but may be variable. The anode 101 is suitably located in proximity to a magnetic lens 103. The magnetic lens is not part of the x-ray source. The magnetic lens is one of the lenses that make up the electron optics of the analyser. The magnetic lens directs electrons toward the analyser.

The x-ray source is adapted for use with an x-ray monochromator. An x-ray monochromator reduces the energy range and focuses the x-ray beam emitted from the x-ray source. Thus, in this embodiment, the instrument includes an x-ray monochromator (not shown). Alternatively the x-ray source may be designed to emit a beam of x-rays directly onto the sample (as shown in the figures) for which XPS analysis is to be performed. In such an arrangement a thin metal foil (typically aluminium or beryllium) can be placed between the anode and the sample and may form part of the x-ray source. Indeed, an instrument for XPS may contain one or more of both types of x-ray source. Thus, an instrument may have an aluminium x-ray source for use with an x-ray monochromator to provide a focused x-ray spot of limited energy spread and a dual, aluminium and magnesium x-ray source for direct unfocussed (or flood) sample irradiation.

The XPS instrument 100 contains, in addition to the x-ray source(s), a device to analyse the photoelectrons emitted from the sample irradiated by the x-ray source(s). This analyser 104 is capable of analysing the energies of the photoelectrons and includes a spherical mirror analyser 105 and a hemispherical analyser arrangement 106. The hemispherical analyser 106 comprises inner hemisphere 108 and outer hemisphere 110. The analyser 104 is adapted to provide both energy and spatial analysis of the emitted electrons to obtain energy filtered parallel images of the sample from where the photoelectrons were emitted. These images are obtained using a spherical mirror analyser arrangement. A suitable device is described in GB-A-2244369.

In a first mode of operation, the instrument 100 is configured to produce a so called parallel image of the sample and/or to produce real time images of the sample (image mode). Electrons emitted from the sample are focussed by electrostatic lens 114 so as to direct the electrons through slit plate 116. (A charge neutraliser 117 may be located prior to the scan plates). Thereafter, the electrons pass into the hemispherical analyser 106 and then through an aperture in the outer hemisphere 110. The electron trajectory is shown as 118 and comprises a reflecting path within the spherical mirror analyser 105, returning to the hemispherical analyser 106 via a second aperture in outer hemisphere 110.

The electrons then pass from the hemispherical analyser 106 to the delay line detector (DLD) 120. The spatial distribution of the electrons at this stage is the same as the spatial distribution at the point where they were emitted from the sample. In this way an image of the sample can be produced. Furthermore, the image can be magnified X times depending on the operating mode of the magnetic and electrostatic lenses.

In a second mode of operation, as illustrated in FIG. 6 (where the same numerals are used for corresponding parts), the instrument 100 is configured to produce an energy dispersed spectrum (so-called spectral mode). In this mode, the emitted electrons take a different trajectory (indicated at 122) compared to the image mode of FIG. 5. Thus, the electrons remain between the inner and outer hemispheres 108, 110 and are thereby distributed across the plane of the detector (120) as a function of their energy. This permits a spectrum or energy distribution to be produced.

### Operating Power

Experimental tests using identical anode-electron beam geometry and with and without the diamond tip have shown that an increase of reliable operating power of about 40% may be achieved.

### Sample Current

In the same comparison the sample current generated by the x-rays produced by the standard x-ray gun and the x-ray gun having a diamond tipped anode of the present invention, monochromated by a monochromator under identical conditions was found to increase in proportion with the power, indicating that the electron gun is operating correctly at the higher power.

Counts from Silver Measured at DLD Mounted in SMA System

The sensitivity of a Nova instrument including delay line detector (DLD) (Nova DLD available from Kratos Analytical Ltd) mounted in a spherical mirror analyser (SMA) (Nova SMA, available from Kratos Analytical Ltd), operating in spectroscopy mode and analysing a clean pure silver foil, showed an increase in performance commensurate with the increase in power.

Importantly, in all of these tests, the diamond tipped anode retained its structural integrity and the bond (In10 braze) between the housing (copper), and the diamond member was not weakened despite exposure to high temperatures at the anode.

In particular, the present inventors have found that the use of a diamond tipped anode in combination with a spherical mirror analyser system and a delay line detector provides particularly high levels of signal to noise and enables higher quality images of a sample to be obtained compared to the use of a standard anode without a diamond member.

We claim:

1. An electrode for use in an x-ray generating apparatus comprising an electron source, the electrode comprising
a housing;
a diamond member mounted to the housing; and
a target located on the diamond member, which target in use is bombarded with electrons from the electron source so as to generate x-rays, wherein a bonding layer is located between the housing and the diamond member, the bonding layer comprising an alloy having a solidus or melting point of less than 900° C.

2. An electrode according to claim 1, wherein the alloy has a solidus or melting point of less than 800° C.

3. An electrode according to claim 2, wherein the alloy has a solidus or melting point in the range 550 to 800° C.

4. An electrode according to claim 3, wherein the alloy has a solidus or melting point in the range 650 to 750° C.

5. An electrode according to claim 1, wherein the bonding layer is formed by brazing.

6. An electrode according to claim 1, wherein the alloy is selected from the group consisting of (1) a silver-copper eutectic; (2) an alloy comprising silver and at least one additional metal; (3) an alloy comprising copper and at least one additional metal; and (4) an alloy comprising copper, silver and at least one additional metal.

7. An electrode according to claim 6, wherein the alloy comprises (1) at least one metal selected from the group consisting of silver and copper, and (2) at least one metal selected from the group consisting of indium, tin, manganese, nickel, titanium and aluminium.

8. An electrode according to claim 7, wherein the alloy comprises silver, copper and indium.

9. An electrode according to claim 8, wherein the alloy comprises, by weight of the total alloy, 55 to 70 wt % silver, 20 to 35 wt % copper and 1 to 15 wt % of at least one additional metal.

10. An electrode according to claim 9, wherein the alloy comprises 60 to 65 wt % silver, 25 to 30 wt % copper and 8 to 12 wt % indium.

11. An electrode according to claim 1, wherein the bonding layer has a thickness in the range 10 μm to 200 μm.

12. An electrode according to claim 1, wherein the housing is formed from a metal selected from copper, silver, tungsten, molybdenum, tantalum, niobium and rhenium.

13. An electrode according to claim 12, wherein the housing is formed from copper.

14. An electrode according to claim 1, wherein the housing comprises at least one conduit for receiving in use a coolant fluid.

15. An electrode according to claim 14, wherein the housing comprises a plurality of heat sink projections extending into the or each said at least one conduit.

16. An electrode according to claim 14, wherein the diamond member is mounted to the housing with respect to the at least one conduit such that in use the diamond member is exposed to the coolant fluid.

17. An electrode according to claim 1, wherein the target and housing are located on opposite sides of the diamond member.

18. An electrode according to claim 1 wherein a first intermediate layer is located between the bonding layer and the diamond member, said first intermediate layer comprising at least one of titanium and chromium.

19. An electrode according to claim 18, wherein the first intermediate layer consists essentially of titanium.

20. An electrode according to claim 18, wherein the first intermediate layer has a thickness in the range 0.01 to 0.2 μm.

21. An electrode according to claim 18, wherein a second intermediate layer is located between the bonding layer and the first intermediate layer, the second intermediate layer comprising at least one of platinum and tungsten.

22. An electrode according to claim 21, wherein the second intermediate layer consists essentially of platinum.

23. An electrode according to claim 21, wherein the second intermediate layer has a thickness in the range 0.05 to 0.5 μm.

24. An electrode according to claim 21, wherein a third intermediate layer is located between the bonding layer and the second intermediate layer, the third intermediate layer comprising at least one of gold, silver, indium, aluminium and magnesium.

25. An electrode according to claim 24, wherein the third intermediate layer consists essentially of gold.

26. An electrode according to claim 24, wherein the third intermediate layer has a thickness in the range 0.2 μm to 5 μm.

27. An electrode according to claim 1, wherein the target comprises at least one of aluminium and magnesium.

28. An electrode according to claim 1, wherein the target is located on an upper face of the diamond member and extends from the upper face along at least one side face of the diamond member to the housing, thereby forming an electrical contact between the target and the housing.

29. An electrode according to claim 24, wherein a fourth intermediate layer is located between the target and the diamond member, the fourth intermediate layer being as defined for the first intermediate layer comprising at least one of titanium and chromium.

30. An electrode according to claim 29, wherein the fourth intermediate layer has a thickness of about 0.1 μm.

31. An electrode according to claim 29, wherein a fifth intermediate layer is located between the target and the fourth intermediate layer, the fifth intermediate layer being as defined for the second intermediate layer comprising at least one of platinum and tungsten.

32. An electrode according to claim 31, wherein the fifth intermediate layer has a thickness of about 0.1 μm.

33. An electrode according to claim 31, wherein the fifth intermediate layer is thinner than the second intermediate layer.

34. An electrode for use in an x-ray generating apparatus comprising an electron source, the electrode comprising
a housing;
a diamond member mounted to the housing; and
a target mounted on the diamond member, which target in use is bombarded with electrons from the electron source so as to generate x-rays, wherein a metal-containing bonding layer is located between the housing and the diamond member, and a first intermediate layer is located between the bonding layer and the diamond member, the first intermediate layer comprising at least one of titanium and chromium.

35. An electrode for use in an x-ray generating apparatus comprising an electron source, the electrode comprising
a housing;
a diamond member mounted to the housing; and
a target located on the diamond member, which target in use is bombarded with electrons from the electron source so as to generate x-rays, wherein a bonding layer is located between the housing and the diamond member, the bonding layer comprising an alloy comprising silver, copper and optionally at least one other metal.

36. Apparatus for generating x-rays, said apparatus comprising an electrode according to claim 35 and an electron source, wherein in use electrons are produced from said electron source and can be incident on the target of the electrode.

37. An x-ray photoelectron spectrometer comprising an electrode according to claim 1.

38. A method of generating x-rays using an electrode according to claim 1.

39. An x-ray photoelectron spectrometer comprising an x-ray source, a spherical mirror analyser and a delay line detector, wherein the x-ray source comprises an electron source and an electrode, the electrode comprising
a housing;
a diamond member mounted to the housing; and
a target located on the diamond member, which target in use is bombarded with electrons from the electron source so as to generate x-rays.
